(19) United States
(12) Patent Application Publication
(10) Pub. No.: US 2015/0116992 A1
(43) Pub. Date: Apr. 30, 2015

(54) LED device for lighting a fishing line at the pole

(71) Applicant: Johnny Ray Massey, Muncie, IN (US)

(72) Inventor: Johnny Ray Massey, Muncie, IN (US)

(21) Appl. No.: 14/523,859

(22) Filed: Oct. 25, 2014

Related U.S. Application Data
(60) Provisional application No. 61/896,216, filed on Oct. 28, 2013.

(51) Int. Cl. A01K 97/12; F21V 23/00; F21V 23/04; F21V 21/08; F21L 4/02; F21V 33/00

(52) U.S. Cl. CPC A01K 97/125; F21L 4/02; F21V 33/008; F21V 23/04; F21V 21/08; F21V 23/004; F21V 23/001; F21Y 2101/02
USPC 362/184

(57) ABSTRACT

A simple and affordable LED device for illuminating part of the rod and the fishing line. The device made of at least one LED; a manner for removably attaching the LED to the fishing pole; a power source for the LED; a way for electrically connecting the power source to the LED; and a method to control electric power to the LED so that the power source energizes the LED and the LED illuminates the line and tip of the fishing pole.

### CROSS-REFERENCE TO RELATED APPLICATIONS

This application claims the benefit of U.S. Provisional Patent Application with Ser. No. 61/896,216 filed Oct. 28, 2013 by Johnny Ray Massey and entitled “A LED device for lighting a fishing line at the pole”.

### FIELD OF INVENTION

This special invention relates to a fishing rod and line, in particular, to a fishing rod that is illuminated by a LED device to illuminate part of the rod and the fishing line.

### FEDERALLY SPONSORED RESEARCH

None.

### SEQUENCE LISTING OR PROGRAM

None.

### BACKGROUND

### Field of Invention and Prior Art

A. Background:

Fishing is one of the most popular recreational activities. Men, women, and children of all ages worldwide enjoy it. Literally millions of people fish on the waterways of their nation. Fresh-water and salt-water fish are sought for food and for the enjoyment of the sport. Many people use a variety of water-craft to reach the best fishing locations, while fishing from the banks of a watercourse or waterway is preferred by other people. Regardless of the purpose for fishing or the location of the pursuit, people who fish make use of a variety of different types of equipment in fulfilling their goals. However, one central piece of fishing equipment is the fishing rod and line. Fishing rods are created in different sizes, shapes, and style each with their own purpose and function. Fly fish rods and spinning rods along with standard rods designed for the traditional open-reel are the three primary type's fishing rod types.

Fishing is often best at dawn and dusk. In addition, night fishing has become popular in many areas. The adequacy of visibility at such times has long been a problem. For example, baiting of hooks, changing of lures, the monitoring of rod movement (principally movement of the tip of the rod) for “nibbles” or “strikes”, locating and opening food and drink on the pier or in the boat, and a myriad of other tasks are difficult in the absence of adequate visibility provided by a steady, even light source with properly adjusted intensity.

B. Problem Addressed

It has been thought by many fisherman that the best fishing, in a number of areas, is found to occur at night. Unless some means is provided on the fishing pole itself for illuminating the line, it is very difficult for the fisherman to know when he has a strike or a nibble. Also, if the fishing pole is dropped in shallow water or on the ground during night fishing, it is often difficult to locate the fishing pole. Many fisherman who engage in night fishing currently rely on the use of flashlights or lanterns or other cumbersome devices to cast sufficient light to enable the fisherman to see the position or movement of the fishing pole, but the use of such sources of light create disadvantages to night fishing in many respects.

However, it would be advantageous to have a fishing rod that had a line that was illuminated by a simple device. This would allow a person fishing at night or other low-light scenarios to have a better view of their fishing rod and associated components. Furthermore, a fishing rod and line illuminated by a device could emit light to the area in and around the rod enabling the user to have a clearer view of the line and any movement, thus allowing the user to fish more skillfully and safely. The present invention provides such a fishing rod.

### PRIOR ART

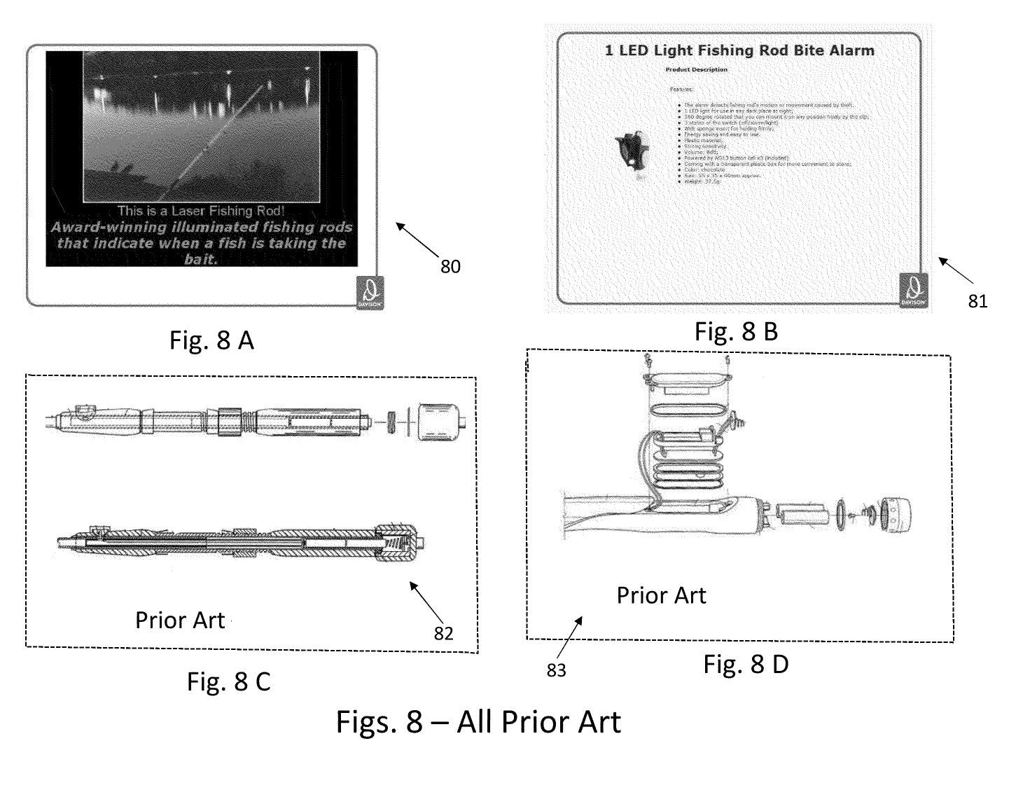

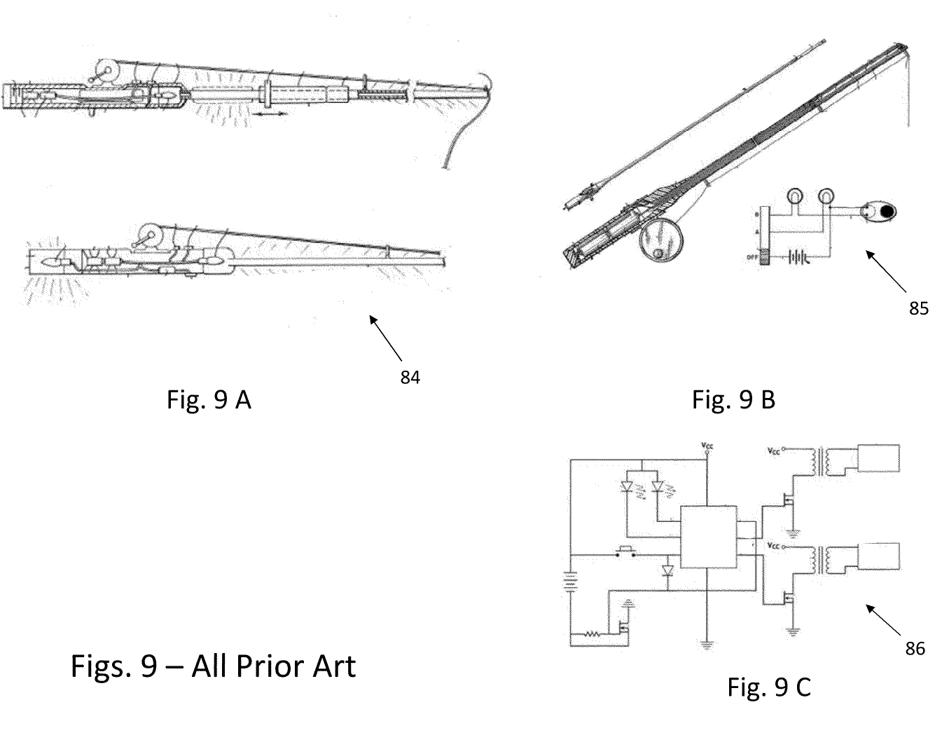

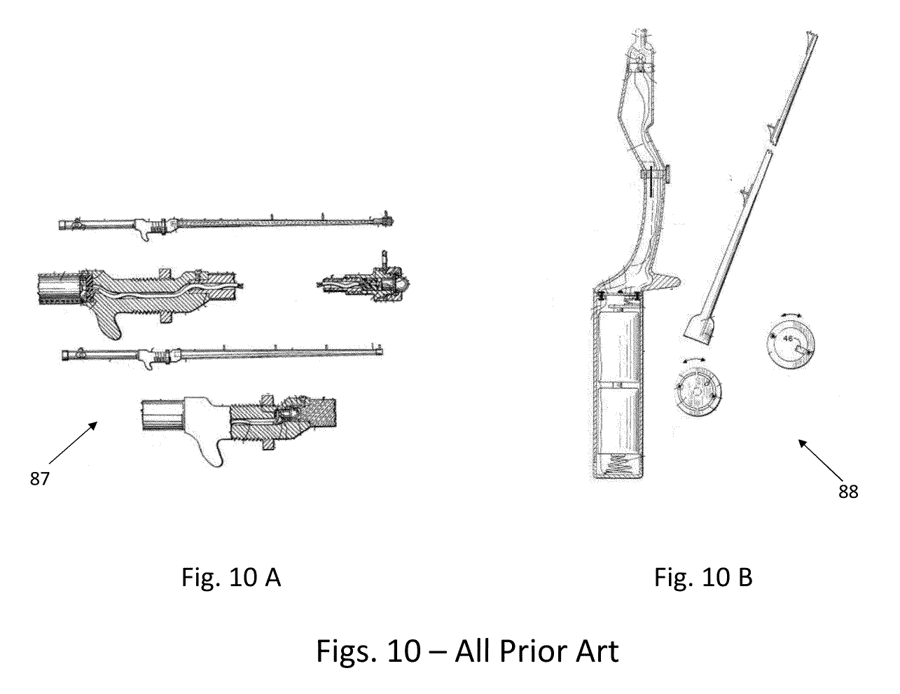

A number of devices have been previously known in the prior art wherein some form of light emitting device or arrangement is associated with a fishing pole for illuminating the length of the fishing pole and line or indicating the position or movement of the fishing pole tip to enable a person using the fishing pole to see the tip position at night or under conditions of low visibility. There are several examples of more expensive and more complicated prior art devices are examples of more expensive and more complicated prior art devices. In the FIGS. 8 A through 8 D, FIGS. 9 A through 9 C and FIGS. 10 A and 10 B are shown prior art on sale of an illuminated rod and fish bite alarm. Other prior art in U.S. Pat. No. 5,406,735 (1995) issued to Howell shows a fishing rod with integral light. Another prior art U.S. Pat. No. 7,051,470 (2006) issued to Lybarger et al. is a battery powered lighted rod. Still more prior art U.S. Pat. No. 4,775,920 (1988) issued to Seybert et al. and prior art U.S. Pat. No. 5,357,410 (1994} issued to Cota et al. are both illuminated/lighted fishing poles. An older prior art U.S. Pat. No. 3,017,499 (1962) showed a complicated illuminated fishing rod. More recent prior art U.S. Pat. No. 4,026,059 (1977) issued to Ochs shows still another lighted fishing rod.

All these prior art devices have, for the most part, been relatively bulky or cumbersome to use and relatively expensive compared with other fishing accessories on the market. Further, the prior art devices frequently interfered with the efficient operation of the fishing pole because of their excessive weight and size. The Massey device is lighter, more compact, uses simple circuitry and available components to light part of the rod and line. And it is affordable in cost to the other devices at generally one-third to one-half or less the cost of others in the marketplace. As it relates to the other prior art in a rather crowded field, it accomplishes a result with a device that has not been anticipated nor is obvious from the other devices. As far as known, there are no LED devices for lighting a fishing line at the pole it is believed that this device is unique in its design and technologies.

### SUMMARY OF THE INVENTION

This new device/process may be simply described as: A Light Emitting Diode (LED) device for a fishing line attached onto a fishing pole comprised of: (a) at least one LED; (b) a means for attaching the LED to the fishing pole; (c) a power source for the LED; (d) a means for connecting the power source to the LED; and (e) a means for controlling the power to the LED wherein the power source energizes the LED and the LED illuminates the line and tip of the fishing pole. An additional feature or alternative description is the said LED device wherein the power source is comprised of at least one battery, a means to control the at least one battery; and a means to encase and connect the at least one battery to the fishing pole.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### Objects and Advantages

Advantages and Benefits are shown as:

| Item | Advantages |
|---|---|
| 1 | Less expensive than line lighting kits |
| | ( 1/3 to ½ the cost) |
| 2 | High intensity light (available LED) |
| 3 | Works on new and existing poles |
| 4 | Simple, no tool options |
| 5 | May be combined with other kits |

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

Now to the accompanying drawings, which are incorporated in and constitute a part of this specification, illustrate an embodiment of the LED device for lighting a fishing line at the pole that is preferred. The drawings together with the summary description given above and a detailed description given below serve to explain the principles of the LED device for lighting a fishing line at the pole. It is understood, however, that the LED device for lighting a fishing line at the pole is not limited to only the precise arrangements and instrumentalities shown.

### BRIEF DESCRIPTION OF THE DRAWINGS

### Figures

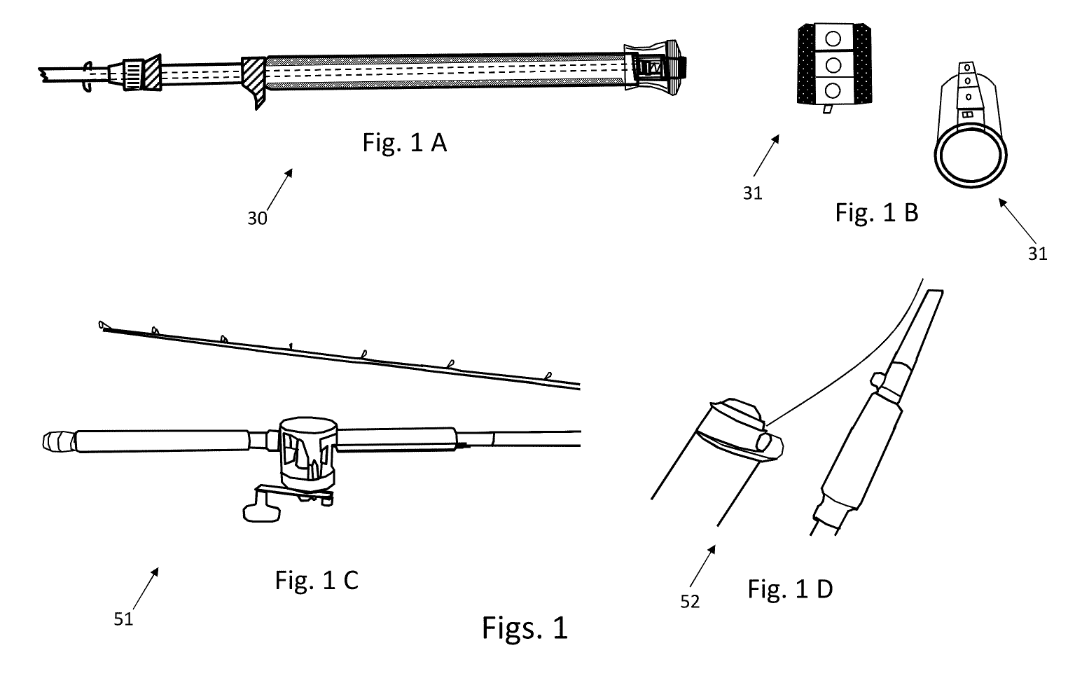

FIGS. 1 A though 1 D are sketches of LED device for lighting a fishing lien at the pole.

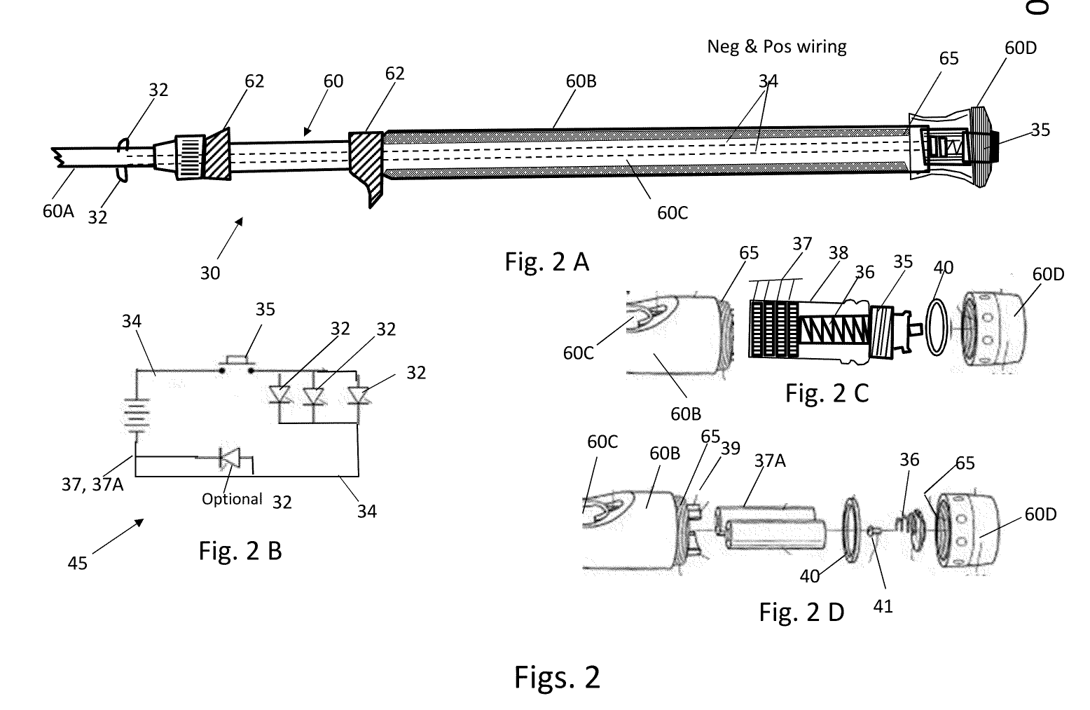

FIGS. 2 A through 2 D are the LED fishing pole device for installation integral the pole.

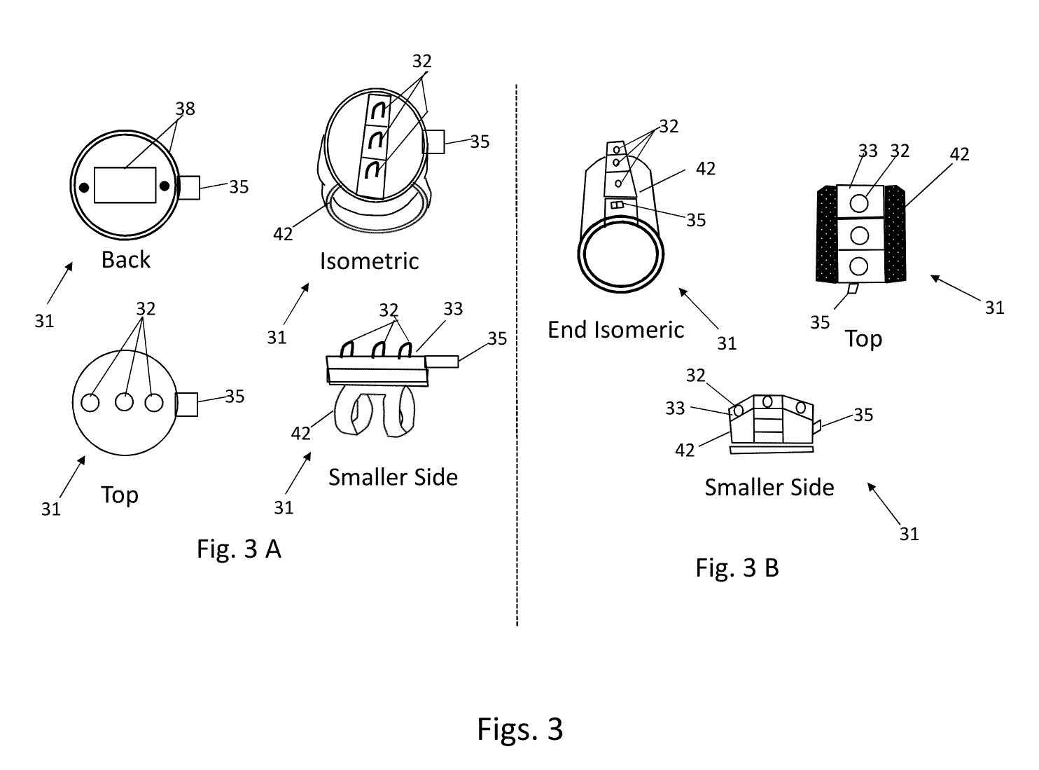

FIGS. 3 A and 3 B are sketches of optimal LED fishing pole devices that may be attached directly to the pole outer surface.

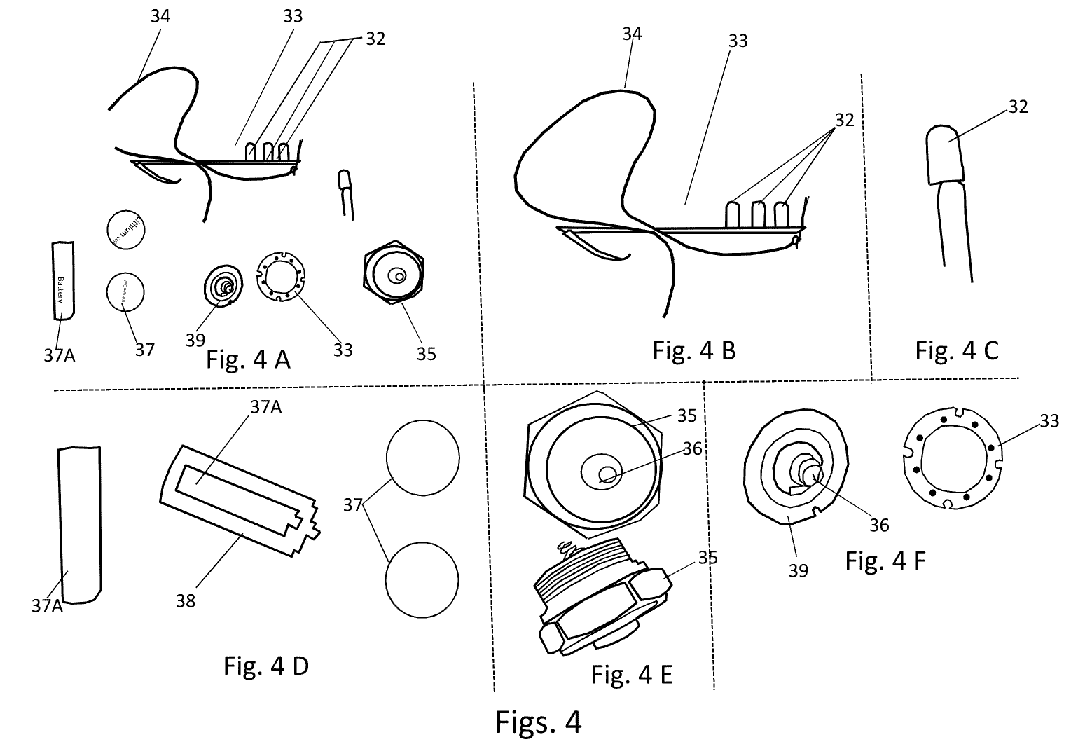

FIG. 4A through 4F are components of the LED fishing pole device and optional devices.

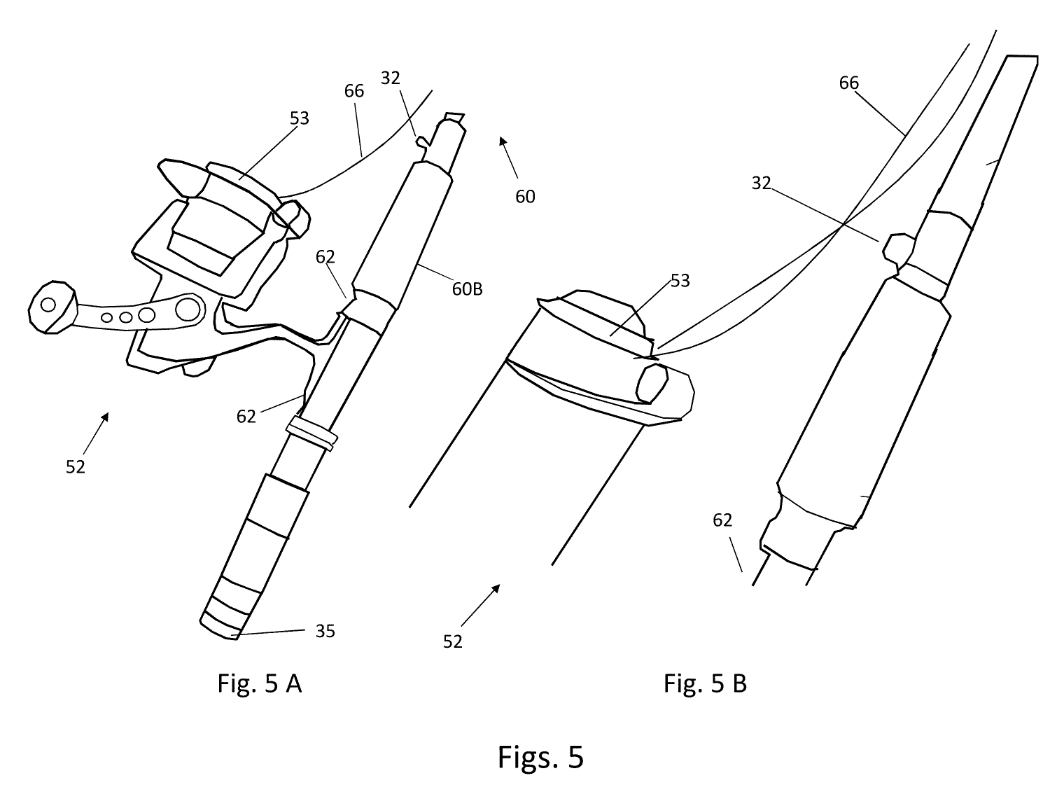

FIGS. 5 A and 5 B are examples of use of the integral LED fishing device with a fishing pole.

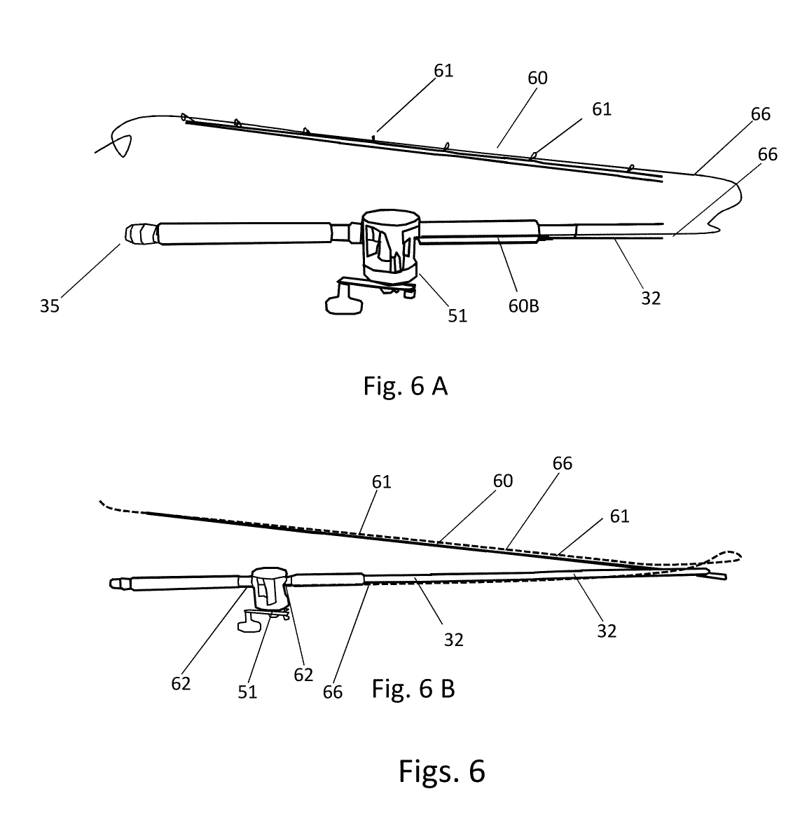

FIGS. 6 A and 6 B are examples of the LED fishing pole device on an open reel.

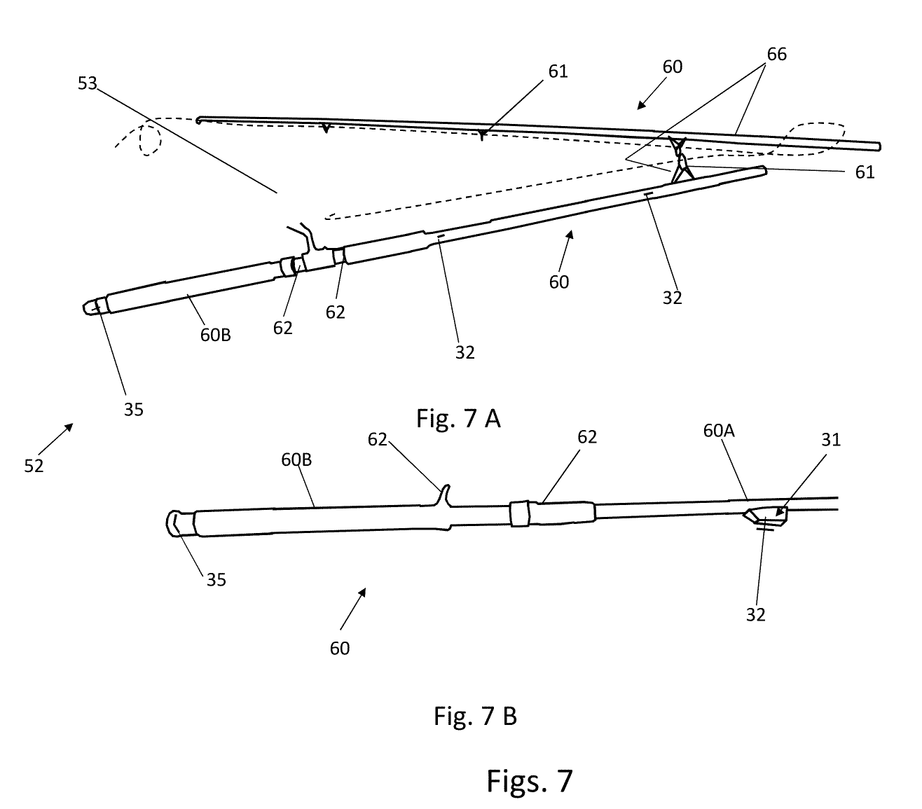

FIGS. 7 A and 7 B are examples of the LED fishing pole device on a spin caster reel and on a base pole (good for different needs).

FIGS. 8 A through 8 D are examples of more expensive and more complicated prior art devices.

FIGS. 9 A through 9 C are other examples of more expensive and more complicated prior art devices.

FIGS. 10 A and 10 B are additional examples of more expensive and more complicated prior art devices.

### DESCRIPTION OF THE DRAWINGS

### Reference Numerals

The following list refers to the drawings:

TABLE A
Reference numbers

| Ref | |
|---|---|
| # | Description |
| 30 | An integral LED device for lighting a fishing line at a pole |
| 31 | An optional LED device for lighting line that may be attached |
| | directly to the pole surface |
| 32 | LED (light emitting diode) |
| 33 | LED mounting board (for multiple LED) |
| 34 | Conductors (wires or the like) |
| 35 | Open/closed switch (pole or push button or slide or toggle) - |
| | a means for controlling the power to the LED |
| 36 | Mounting spring for batteries to switch |
| 37 | Flat disk Lithium cell batteries (such as CA2016, 2032 etc.) |
| 37A | Small cylinder Battery (such as 2A, 2AA, 2AAA) |
| 38 | Means for securing battery (batteries) |
| 39 | Connecting plate (batteries to switch or to conductors) |
| 40 | Sealing gasket |
| 41 | Connector pin (optional) |
| 42 | Means to removably connect optional 31 to exterior pole |
| | surface 60A (such as Velcro RTM, adhesive faced tape, metal |
| | or plastic spring clip, etc.) |
| 45 | Typical electrical diagram |
| 50 | Use of the LED device on an open bait casting reel |
| 51 | Open end bait casting reel |
| 52 | Use of the LED device on a spin casting reel |
| 53 | Spin casting reel |
| 60 | Fishing pole |
| 60A | Fishing pole surface |
| 60B | Fishing pole grip/sponge/cork/composite material/ |
| | synthetic plastic etc. |
| 60C | Fishing pole aperture and hollow throughout the pole 60 |
| 60D | Fishing pole end cap |
| 61 | Pole line eyelets |
| 62 | Means for removably connecting reel to pole |
| 65 | Means to connect cap 60D to pole 60 |
| 66 | Fishing Line |
| 80 | Prior art Illuminated Rod |
| 81 | Prior art Fish bite alarm |
| 82 | Prior art U.S. Pat. No. 5,406,735 |
| 83 | Prior art U.S. Pat. No. 7,051,470 |
| 84 | Prior art U.S. Pat. No. 4,775,920 |
| 85 | Prior art U.S. Pat. No. 5,357,410 |
| 86 | Prior art U.S. Pat. No. 7,051,470 - circuit |
| 87 | Prior art U.S. Pat. No. 3,017,499 |
| 88 | Prior art U.S. Pat. No. 4,026,059 |

### DETAILED DESCRIPTION OF PREFERRED EMBODIMENT

The present development is a LED device for illuminating the fishing line of a pole at night. The device is used to illuminate part of the rod and the fishing line.

There is shown in FIGS. 1-10 a description and operative embodiment of the LED device for lighting a fishing line at the pole. In the drawings and illustrations, one notes well that the FIGS. 1-4 demonstrate the general configuration, and FIGS. 5-7 show examples but not limitations of the use and operation of LED device for lighting a fishing line at the pole. FIGS. 8-10 show examples of the prior art in this field. The various example uses are in the operation and use section, below.

The accompanying drawings, which are incorporated in and constitute a part of this specification, illustrate an embodiment of the LED device 30 for lighting a fishing line at the pole 60 that is preferred. The drawings together with the summary description given above and a detailed description given below serve to explain the principles of the LED device 30 for lighting a fishing line at the pole 60.

The advantages of the LED device for lighting a fishing line at the pole include:
1. Less expensive device (1/3 to 1/2 the cost) than a line lighting kits,
2. High intensity light,
3. Works on new and existing poles,
4. Simple, no tool options, and
5. May be combined with other kits.

This new device 30/process may be simply described as: a Light Emitting Diode (LED) device for a fishing line attached onto a fishing pole comprised of: (a) at least one LED; (b) a means for attaching the LED to the fishing pole; (c) a power source for the LED; (d) a means for connecting the power source to the LED; and (e) a means for controlling the power to the LED wherein the power source energizes the LED and the LED illuminates the line and tip of the fishing pole. An additional feature or alternative description is the said LED device wherein the power source is comprised of at least one battery, a means to control the at least one battery; and a means to encase and connect the at least one battery to the fishing pole. The preferred device is a Light Emitting Diode (LED) device for a fishing line attached onto a fishing pole, the device comprised of: (a) three essentially equally spaced LEDs; (b) three Velcro® straps for removably attaching each of the three LED to the fishing pole; (c) an electric power source comprised of two flat disk Lithium batteries with an amount of electric power for the LED; (d) a means to encase and connect the two flat disk Lithium batteries to the fishing pole; (e) a pair of electric wires for electrically connecting the power source to the three LEDs; and (f) a push button mounted in a grip of the fishing pole to control the electric power to the LED wherein the power source energizes the LED and the LED illuminates the line and tip of the fishing pole.

FIGS. 1 A though 1 D are sketches of LED device for lighting a fishing lien at the pole. FIG. 1 A is an integral LED device 30 for lighting a fishing line 66 at a pole 60. FIG. 1 B are optional LED devices 31 for lighting line 66 that may be attached directly to the pole surface 60A. FIG. 1 C shows an open end casting reel 51, and FIG. 1 D demonstrates a use 52 of the LED device on a spin casting reel.

FIGS. 2 A through 2 D are the LED fishing pole device for installation integral the pole. Sown in FIG. 2 A is an integral LED device 30 for lighting a fishing line 66 at a pole 60. The components shown are at least one LED (light emitting diode) 32, conductors 34 (wires, circuit boards, leads, thin bands or the like—both the negative and positive leads), an open/closed switch 35 (pole, push button, slide, toggle or equal as a means for controlling the power to the LED), a fishing pole 60, a fishing pole surface 60A, a fishing pole grip 60C—sponge/cork/etc., fishing pole hollow aperture 60D throughout the pole 60C, a fishing pole end cap 60D, a means 62 for removably connecting reel to pole 60, and a means 65 to connect cap 60D to pole 60. FIG. 2 B is a circuit diagram 45 with at least one LED 32 (which may be attached directly to the pole surface 60A—not shown), the said LEDs 32 may be connected preferably in series and optionally in parallel, a LED mounting board 33 (not shown but for multiple LED 32), conductors 34 (wires or the like), an open/closed switch 35 (pole switch/toggle/slide or push button—as a means for controlling the power to the LED), flat disk lithium cell batteries 37 (such as CA2016, 2032 etc.) or alternatively battery 37A (small cylindrical such as 2AA, 2AAA) and (not shown) a means for securing battery (batteries) 38. This means 38 can be a small, lightweight tray or structure to encase the batteries and/or switch. FIG. 2 C shows a fishing pole grip 60B—sponge/cork/composite material/synthetic plastic etc., a fishing pole hollow aperture 60C throughout the pole 60, a fishing pole end cap 60D, a means 65 to connect cap 60D to pole 60, a switch 35 (pole or push button), a mounting spring 36 for batteries to switch, a set of one or more flat disk lithium cell batteries 37 (such as CA2016, 2032 etc.), a means for securing battery (batteries) 38 and a sealing gasket 40. FIG. 2 D shows a fishing pole grip 60B—sponge/cork/etc., a fishing pole hollow aperture 60C throughout the pole 60, a fishing pole end cap 60D, a means 65 to connect cap 60D to pole 60, a mounting spring 36 for batteries to switch, a set of battery(ies) 37A (small cylindrical such as 2AA, 2AAA), a connecting plate 39 (batteries to switch or to conductors), a sealing gasket 40, and a connector pin 41 (optional).

FIGS. 3 A and 3 B are sketches of optimal LED fishing pole devices that may be attached directly to the pole outer surface. FIG. 3 A shows a Top, Side, Back and Isometric view of an optional LED device 31 for lighting line 66 that may be attached directly to the pole surface 60A. The components include at least one LED (light emitting diode) 32, a LED mounting board 33 (for multiple LED), an open/closed switch 35 (pole switch/toggle/slide or push button), a means for securing battery (batteries) 38, and a means to connect 42 device 31 to exterior pole surface 60A (such as Velcro®, adhesive faced tape, metal or plastic spring clip, etc.). FIG. 3 B shows a Top, End, and Isometric view of an optional LED device 31 for lighting line 66 that may be attached directly to the pole surface 60A. The components include at least one LED (light emitting diode) 32, a LED mounting board 33 (for multiple LED), an open/closed switch 35 (pole or push button), a means for securing battery (batteries) 38, and a means to connect 42 device 31 to exterior pole surface 60A (such as Velcro®, adhesive faced tape, metal or plastic spring clip, etc.).

FIG. 4A through 4F are components of the LED fishing pole device 30 and optional devices 31. Shown in these views are components described above as the LED (light emitting diode) 32, LED mounting board 33 (for multiple LED), conductors 34 (wires or the like), open/closed switch 35 (pole or push button), mounting spring 36 for batteries to switch, flat disk lithium cell batteries 37 (such as CA2016, 2032 etc.), battery 37A (small cylindrical such as 2AA, 2AAA), means for securing battery (batteries) 38, and connecting plate 39 (batteries to switch or to conductors).

FIGS. 5 A and 5 B are examples of use of the integral LED fishing device pole. FIGS. 6 A and 6 B are examples of the LED fishing pole device on an open real. FIGS. 7 A and 7 B are examples of the LED fishing pole device on a spin coaster and on a base pole (good for different needs). These uses and operations with the device are described in further detail below.

FIGS. 8 A through 8 D; FIGS. 9 A through 9 C; and FIGS. 10 A and 10 B are several examples of more expensive and more complicated prior art devices are examples of more expensive and more complicated prior art devices. Here are shown prior art Illuminated rod 80, prior art fish bite alarm 81, prior art U.S. Pat. No. 5,406,735—82, prior art U.S. Pat. No. 7,051,470—83, prior art U.S. Pat. No. 4,775,920—84, prior art U.S. Pat. No. 5,357,410—85, prior art circuit: U.S. Pat. No. 7,051,470—86, prior art U.S. Pat. No. 3,017,499—87, and prior art U.S. Pat. No. 4,026,059—88.

The details mentioned here are exemplary and not limiting. Other specific components and manners specific to describing a fishing pole line lighting apparatus device 30 may be added as a person having ordinary skill in the field of fishing pole accessories and lighting devices and their uses well appreciates.

### OPERATION OF THE PREFERRED EMBODIMENT

The LED device 30 for lighting a fishing line at the pole 60 has been described in the above embodiment. The manner of how the device operates is described below. This new device 30/process may be simply described as: a Light Emitting Diode (LED) device for a fishing line attached onto a fishing pole comprised of: (a) at least one LED; (b) a means for attaching the LED to the fishing pole; (c) a power source for the LED; (d) a means for connecting the power source to the LED; and (e) a means for controlling the power to the LED wherein the power source energizes the LED and the LED illuminates the line and tip of the fishing pole. The preferred device is a Light Emitting Diode (LED) device for a fishing line attached onto a fishing pole, the device comprised of: (a) three essentially equally spaced LEDs; (b) three Velcro® straps for removably attaching each of the three LED to the fishing pole; (c) an electric power source comprised of two flat disk Lithium batteries with an amount of electric power for the LED; (d) a means to encase and connect the two flat disk Lithium batteries to the fishing pole; (e) a pair of electric wires for electrically connecting the power source to the three LEDs; and (f) a push button mounted in a grip of the fishing pole to control the electric power to the LED wherein the power source energizes the LED and the LED illuminates the line and tip of the fishing pole. An additional feature or alternative description is the said LED device wherein the power source is comprised of at least one battery, a means to control the at least one battery; and a means to encase and connect the at least one battery to the fishing pole.

FIGS. 5 A and 5 B are examples of use of the integral LED fishing device 30 on a fishing pole 60. Shown in these figures are use 52 on the open spin casting reel 53, an open/closed switch 35 (pole or push button), the means 62 for removably connecting a reel 53 to a pole 60, the pole 60 itself, the pole surface 60A, the pole grip 60B, the LED 32 and the fishing line (to be illuminated) 66.

FIGS. 6 A and 6 B are examples of the LED fishing pole device 30 on an open bait casting reel 51. Shown in these figures are the open bait casting reel 51, an open/closed switch 35 (pole or push button), the means 62 for removably connecting a reel 51 to a pole 60, the pole 60 itself, the pole eyelets 61, the pole grip 60B, the LED 32 and the fishing line (to be illuminated) 66.

FIGS. 7 A and 7 B are examples of the LED fishing pole device 30 on a spin caster reel 53 and on a base pole 60 (good for different needs). Shown in FIG. 7 A is the use 52 on the open spin casting reel 53, an open/closed switch 35 (pole or push button), the means 62 for removably connecting a reel 53 to a pole 60, the pole 60 itself, the pole grip 60B, the LED 32, the pole eyelets 61 and the fishing line (to be illuminated) 66. FIG. 7 B shows a standard pole 60, the means 62 for removably connecting a reel 53 to a pole 60, the pole 60 itself, the pole grip 60B, the pole surface 60A, and the optional LED device 31 for lighting line 66 that may be attached directly to the pole surface 60A.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing FIGS. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

With this description it is to be understood that the LED device 30 for lighting a fishing line at the pole 60 is not to be limited to only the disclosed embodiment of product. The features of the LED device 30 for lighting a fishing line at the pole are intended to cover various modifications and equivalent arrangements included within the spirit and scope of the description.

The present disclosure includes that contained in the appended claims, as well as that of the foregoing description. Although this invention has been described in its preferred form with a certain degrees of particularity, it is understood that the present disclosure of the preferred form has been made only by way of example and that numerous changes in the details of construction and the combination and arrangements of parts may be resorted to without departing from the spirit of the invention.

Now that the invention has been described:

What is claimed is:

1. A Light Emitting Diode (LED) device for a fishing line attached onto a fishing pole, the device comprised of:
(a) at least one LED;
(b) a means for removably attaching the LED to the fishing pole;
(c) an electric power source with an amount of electric power for the LED; and
(d) a means for electrically connecting the power source to the LED;
(e) a means to control the electric power to the LED wherein the power source energizes the LED and the LED illuminates the line and tip of the fishing pole.

2. The device of claim 1 wherein the power source is further comprised of at least one battery and a means to encase and connect the at least one battery to the fishing pole.

3. The device of claim 2 wherein the means to control electric power is a switch that is selected from the group consisting of pole, push button, slide and toggle switches.

4. The device of claim 2 wherein the electric power source with an amount of electric power for the LED is selected from the group consisting of flat disk Lithium cell batteries (such as CA2016, 2032 etc.) and a small cylinder battery (such as 2A, 2AA, 2 AAA).

5. The device of claim 2 wherein the means for removably attaching the LED to the fishing pole is selected from the group consisting of Velcro®, adhesive faced tape, metal clip, metal spring, plastic spring and plastic clip.

6. The device of claim 2 wherein the means for electrically connecting the power source to the LED is selected from the group consisting of electrical wires and an electrical circuit board.

7. A Light Emitting Diode (LED) device for a fishing line attached onto a fishing pole, the device comprised of:
(a) three essentially equally spaced LEDs;
(b) three Velcro® straps for removably attaching each of the three LED to the fishing pole;
(c) an electric power source comprised of two flat disk Lithium batteries with an amount of electric power for the LED;
(d) a means to encase and connect the two flat disk Lithium batteries to the fishing pole
(e) a pair of electric wires for electrically connecting the power source to the three LEDs; and
(f) a push button mounted in a grip of the fishing pole to control the electric power to the LED
wherein the power source energizes the LED and the LED illuminates the line and tip of the fishing pole.
